(19) United States
(12) Patent Application Publication
(10) Pub. No.: US 2014/0316854 A1
(43) Pub. Date: Oct. 23, 2014

(54) INTEGRATED PRE-TAIL, E-TAIL AND RETAIL PLATFORM

(71) Applicant: Vianza, Inc., San Francisco, CA (US)

(72) Inventors: Jayant Kumar PATNAIK, Fremont, CA (US); Debasmita Patnaik, Fremont, CA (US)

(21) Appl. No.: 14/256,675

(22) Filed: Apr. 18, 2014

Related U.S. Application Data
(60) Provisional application No. 61/813,466, filed on Apr. 18, 2013.

(51) Int. Cl. G06Q 30/02

(52) U.S. Cl. CPC G06Q 30/0202
USPC 705/7.31

(57) ABSTRACT

An online pre-tail, e-tail and re-tailing platform that facilitates various commercial transactions between buyers and sellers is disclosed herein. The platform has ability to display products that are submitted by sellers, validate and generate demands for the products, arrange manufacturing and fulfill orders. The manufacturing of the product is funded at least in part by funds from the preorders received prior to the manufacturing.

### PRIORITY CLAIM

This application is a U.S. non-provisional patent application that claims the benefit of U.S. provisional patent application No. 61/813,466, entitled “ONLINE MARKETPLACE,” filed on Apr. 18, 2013, which is incorporated by reference herein in its entirety.

### FIELD OF THE INVENTION

At least one embodiment of the present invention relates to the field of electronic commerce. In particular, the present invention relates to a computer and internet-based commerce system for handling the requests, biddings, and procurement activities between agencies, organizations and businesses and an array of manufacturers for commodities, including goods and services.

### BACKGROUND

Electronic commerce, commonly known as e-commerce or ecommerce, is a type of industry where the buying and selling of products or services is conducted over electronic systems such as the Internet and other computer networks.

Electronic commerce is generally considered to be the sales aspect of e-business. It also consists of the exchange of data to facilitate the financing and payment aspects of business transactions.

However, present-day electronic commerce platforms lack effective methods to predict, validate and generate demand for a specific product. Consequently, the lack of demand information makes it hard for retailers to place wholesale orders through electronic commerce platforms.

### SUMMARY

In accordance with one aspect of the present invention, disclosed hereunder, is an online pre-tail, e-tail and retail platform that facilitates various commercial transactions between buyers and sellers. The platform has the ability to display products that are submitted by sellers, predict and validate demand for the products, generate demand for the products, arrange manufacturing and fulfill the orders. The transactions can be performed using methods and systems disclosed in the following discussion.

In various embodiments of the method, a transaction is initiated by a seller, such as a designer, to upload a description of a new product to the platform. However, the new product is yet to be made. Consequently, the platform displays the description of a product, and the description of this product is available to millions of buyers who are connected to the Internet. In one embodiment, the new product can be one-of-a-kind ideas, which may feature innovation regarding design, quality or functionality of a product. In another embodiment, the new product can be a product that never existed, a designer collaboration with a tastemaker or retailer, a new collection by the designer, or a limited edition launch of an existing product.

In one embodiment, seller can be a seller of the product. Retailer can be a wholesale buyer of the product. Consumer can be an individual who buys the product at retail price. Manufacturer can be a producer of the product.

Any buyer who is interested in the new product can submit a preorder that can include one or more new products. In fact, the buyer can be an individual consumer or a retailer. Maintaining a database for information, such as preorders from all the buyers, the platform may promote the product through media channels, such as social media, TV, radio, designers' bloggers and other media formats. The platform also generates wholesale orders from retailers by demonstrating whether the quantity of preorders to date exceeds a predetermined value, thus convincing retailers there is enough demand among consumers for the new product.

In one embodiment, the platform can gauge product demand before it goes into production. In addition, the platform can also receive new designs and solicit product feedback to enhance design both from consumers and retail buyers. For example, product feedback can be solicited via comments on the products or privately via structured survey forms. In fact, the platform has the ability to take pre-orders to fund production or meet production minimums by selling directly to consumers and wholesale to retailers. In one embodiment, the platform can minimize holding inventory and then liquidate the inventory if the product does not sell. Therefore, the platform can pass on the benefit to early adopters by lowering price or providing early access to innovation or additional perks like numbered limited edition products.

In one embodiment, the platform can drive traffic to a website and promote designer specific campaigns via search, email, social media, public relations efforts, platform-owned channels, strategic partnerships with media partners, design bloggers, and other methods. In another embodiment, the platform provides integrated marketing tools for designers to amplify the brand voice across multiple channels. The platform also grants designers access to a growing database of retailers to whom they may market their product via targeted email campaigns. In addition, the platform also enables product distribution APIs to seamlessly integrate designers' products into any online retailers ecommerce site for a broader reach. Furthermore, the platform also provides visual merchandising tools which enable consumers and retail buyers to create wish lists for future buying opportunities that become an indicator of demand.

In one embodiment, the platform tracks product views, social media sentiment and statistics, press coverage, retail and wholesale orders placed, and provides advanced analytics and actionable insights to the retail channel to identify trends, thus providing evidence of product demand and generating wholesale orders and broader distribution opportunities.

In another embodiment, the platform can also recommend one or more manufacturers from a number of manufacturers who may manufacture the new product. This recommendation of manufacturers is based on the reputation of the manufacturer, the manufacturing history of the manufacturer, the cost of manufacturing at the manufacturer, and other factors. Moreover, the manufacturing of the product is funded at least in part by funds from pre-orders made by buyers.

The platform also has the ability to arrange delivery of the manufactured products between the retailers and the buyers who have already placed orders. In addition, the platform also has the ability to receive pre-orders as a way to fund production or meet production minimums by selling directly to consumers and wholesale to retailers.

In one embodiment, designers can invite manufacturers to the platform in order to collaborate on the making of the product. Furthermore, designers can also add design documents, specifications to their production orders and use a commenting function within the order as a way to negotiate price, delivery dates, lead times, or to fine tune the design. Consequently, all communication can be captured in the order and centralized for future reference. Designers can also track all orders from “request for quote” (RFQ) through order fulfillment stage and pay on the platform using a credit card or credit terms.

In certain embodiments, the online marketplace supports three types of product pricing for wholesalers/brands. If a product does not have a price defined, it is not available for sale. This distinguishes between the concept of defining a price versus declaring a price for a product. When a product has a defined price, it could be that the price of the product shows as a numeric value (for example, $65 per pack or 20) or it could be that the price is defined but is not shown to casual browsers in the marketplace. In the latter case, the price is not declared but will be provided by the brand when anyone sends an RFQ. This is denoted on the online marketplace as POR (Price On Request).

In both of these cases, the product has a defined price and may be used in RFQs. This is used as opposed to showing a product without a price defined at all. A product with a POR pricing cannot be put in an order. Thus, if a buyer's cart consists of a product that has a pricing identified as POR, the buyer will not be permitted to “place order” from the cart itself as the pricing of this product is still not declared. Here, a received quote from a brand may not contain a product with POR as the price. A received quote must have declared values for all products that are part of the quote request so that a retailer can “place order” based on the received quote.

The online marketplace enables brands to create multiple pricelists for products in their catalog. There are two main types of pricelists supported by the marketplace—base pricelists and promotional pricelists. Each pricelist may be associated with effective start and end dates. The end date may be unspecified to indicate that the pricelist does not have an expiration date. Usually this is true for a base pricelist while promotional pricelists are created with a specific end date to denote when the promotional pricing period ends. In embodiments, in the online marketplace, a pricelist may be effective only for a set of one or more specific countries. There may be only one base pricelist per country (of buyer) effective at any given point of time.

In embodiments, the online market place may require a base pricelists effective per country at any given time. Usually, the base pricelist contains the prices for most products in a brand's catalog. In embodiments, the online market may allow for setting an end date to the existing base pricelist and creating a new one from a date just after the expiration date of the previous base pricelist when the base pricing for the entire catalog (or a substantial number of products in the catalog) needs to be revised. In embodiments, the online marketplace allows changes in the pricing for a specific product in the base pricelist if the revision applies only to a few products. In embodiments, the online market place may require a given brand to ensure that there is only one promotional pricelist effective at any given time containing any one product from its catalog.

Promotional pricelists are used to provide deviations (typically breaks) from the normal products pricing in the base pricelist for short periods to incent purchase. In embodiments, the online marketplace may restrict promotional pricelists from including all products in a brand's catalog, restricting such lists by an end date. Similar to base pricelists, these pricelists also are applicable to only a defined set of countries.

In one embodiment, retailers can “request to reserve inventory” without paying for it by selling products on their online ecommerce sites and then notifying designers to drop-ship the goods directly to the consumer. All such transactions are tracked on the platform. In addition, designers can track all orders across both “Business-to-Consumer” and “Business-to-Business” channels from placement to fulfillment. Furthermore, designers can confirm or reject orders from retailers if they do not choose to sell to a particular retailer based on other brands that the particular retailer carries. Moreover, all workflows for in-stock, made to order, samples, and pre-ordered products are automated and payment processing for the different order types is facilitated by the platform.

Other aspects of the technology introduced here will be apparent from the accompanying figures and from the following descriptions.

### BRIEF DESCRIPTION OF THE DRAWINGS

FIG. 1 illustrates an example of a pre-tail, e-tail and retail marketplace.

FIG. 2 illustrates a flow chart that describes an example of how the platform can facilitate the transaction in the pre-tail, e-tail and retail marketplace.

FIG. 3 illustrates a flow chart that describes another example of how the platform can facilitate the transaction in the pre-tail, e-tail and retail marketplace.

FIG. 4 illustrates an example of how the computer platform promotes products by using multiple channels.

FIG. 5 is a high-level block diagram showing an example of the architecture of a computer server, which may represent any computer running the database management system described herein.

### DETAILED DESCRIPTION

References in this specification to “an embodiment,” “one embodiment,” or the like mean that the particular feature, structure, or characteristic being described is included in at least one embodiment of the present invention. However, occurrences of such phrases in this specification do not all necessarily refer to the same embodiment.

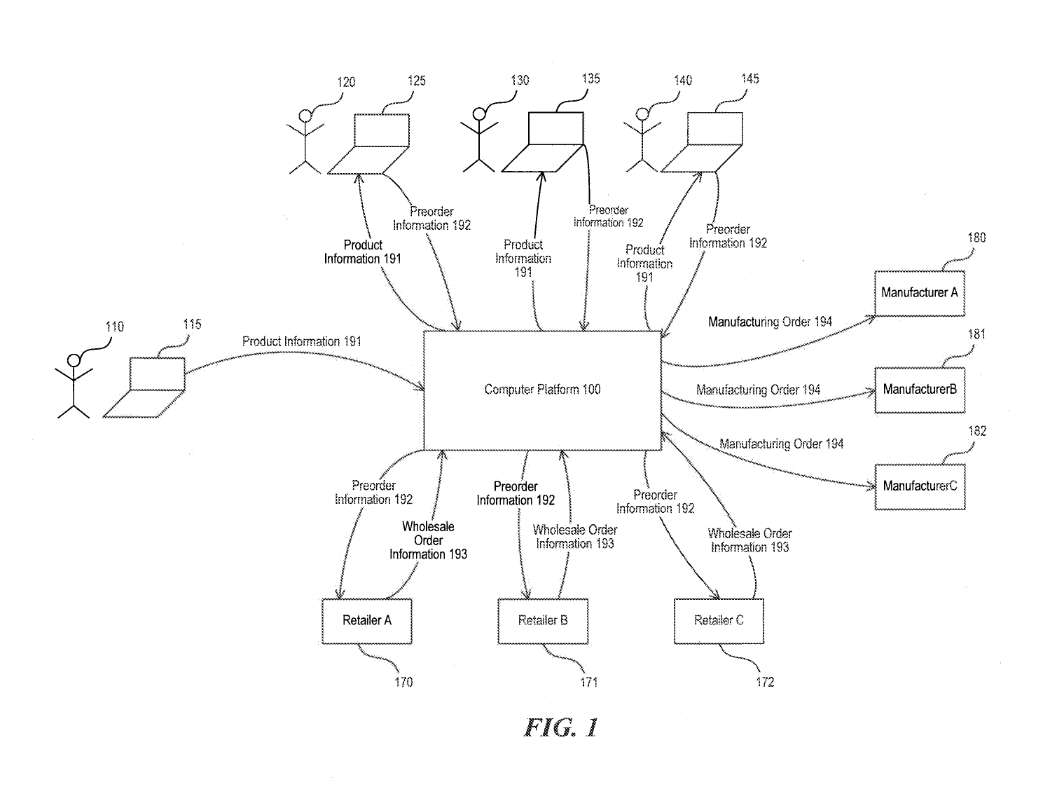

FIG. 1 illustrates an example of a pre-tail, e-tail and retail marketplace. The marketplace includes a computer platform 100 configured to facilitate transactions between multiple parties. In one embodiment, a seller 110, who can be a designer, submits product information 191 through a computer 115 to the computer platform 100.

In one embodiment, a seller 110, such as a designer of new products, can create a collection to showcase his/her products as a grouping. There may be any number of products within a collection and any product may be part of any number of collections. A given collection has a name and an image associated with it. The seller can use a personal computer 115, such as a desktop computer or a portable computer, to upload product information 191 to the website supported by the computer platform 100.

In one embodiment, a transaction is initiated by a seller 110, such as a designer, to upload a description of a new product to the platform. However, the new product is yet to be made. Consequently, the platform displays the description of a product and the product information 191 is available to any buyers who are connected to the Internet. In one embodiment, the new product can be one-of-a-kind ideas, which feature innovation in regard to design, quality, or functionality of a product. In another embodiment, the new product can be a product that never existed (tech gadget), a designer collaboration with a tastemaker or retailer, a new collection by the designer, or a limited edition launch of an existing product.

In one embodiment, after product information 191 is displayed on the website related to computer platform 100, buyer A 120, who is an individual consumer, can submit preorder information 192 through a personal computer 125 to the computer platform 100. In one embodiment, after product information 191 is displayed on the website related to computer platform 100, buyer B 130, who is a retailer, can submit preorder information 192 through a personal computer 135 to the computer platform 100. In one embodiment, after product information 191 is displayed on the website related to computer platform 100, buyer C 140, who is a distributor, can submit preorder information 192 through a personal computer 145 to the computer platform 100. In one embodiment, the preorder submitted by buyer A 120, buyer B 130, and buyer C 140 can be different. Buyer A 120 can submit product comments within the preorder information 192 to the computer platform. The product comments can include the further improvement suggestions, the expectation from a buyer, and ideal price range for the product.

In one embodiment, computer platform 100 integrates preorder information 192 from all the buyers and maintains a database for all products' preorder information 192 within the computer platform. Computer platform 100 can send the aggregated preorder information 192 of a particular product to retailer A 170 that mostly operates in large cities. Computer platform 100 can send the aggregated preorder information 192 of a particular product to retailer B 171, who operates in small cities. Computer platform 100 can send the aggregated preorder information 192 of a particular product to retailer C 172, who has operations abroad. Additionally, the computer platform 100 promotes the product through media channels, such as social media, TV, radio, designers' bloggers and other media formats. In one embodiment, the computer platform 100 can post a designer's story of creating the product in the designer's blog in order to promote the product.

In one embodiment, the computer platform 100 provides integrated marketing tools to a designer 110 to amplify the brand voice across multiple channels. The computer platform 100 also can track product reviews, social media sentiment and statistics, press coverage, retail, and wholesale orders placed to date, and also provide advanced analytics and actionable insights to the retail channel to identify trends, providing social proof of product demand and generating wholesale orders and broader distribution opportunities

In one embodiment, the computer platform 100 generates wholesale orders from retailer A 170, retailer B 171 and retailer C 172 by proving that the quantity of preorders to date exceeds a predetermined value, thus convincing the retailers that there is enough demand among consumers for the new product.

In one embodiment, retailer A 170 can submit wholesale order information 193 to computer platform 100. The wholesale order information 193 includes the quantity information of the wholesale order. The quantity of wholesale orders is determined based at least in part upon the quantity of the preorders. In one embodiment, retailer B 171 can submit wholesale order information 193 to computer platform 100. The wholesale order information 193 includes the quantity information of the wholesale order. The quantity of wholesale orders is determined based at least in part upon the quantity of the preorders. In one embodiment, retailer C 172 can submit wholesale order information 193 to computer platform 100. The wholesale order information 193 includes the quantity information of the wholesale order. The quantity of wholesale orders is determined based at least in part upon the quantity of the preorders.

In one embodiment, the computer platform 100 can recommend a shortlist of manufacturers for final selection by the designer or the originator of the design. For example, the computer platform 100 can also recommend manufacturer A 180 and submit manufacturing order 194 to manufacturer A 180 after the decision is made because manufacturer A 180 has a good reputation regarding product quality control. In one embodiment, the computer platform 100 can also recommend manufacturer B 181 and submit manufacturing order 194 to manufacturer B 181 after the decision is made because manufacturer B 181 has a long history of making similar products. In one embodiment, the computer platform 100 can also recommend manufacturer C 182 and submit manufacturing order 194 to manufacturer C 182 after the decision is made because manufacturer C 182 has low manufacturing cost.

In one embodiment, the manufacturing history of the manufacturer, the cost of manufacturing at the manufacturer and other factors are taken into consideration when computer platform 100 recommends a manufacturer, Moreover, the manufacturing of the product is funded at least in part by funds from pre-orders of buyers, including but not limited to the pre-orders of buyer A 120, buyer B 130 and buyer C 140.

In one embodiment, computer platform 100 also has the ability to take preorders to fund production or meet production minimums by selling directly to consumers as well as wholesale to retailers. The retailers have choice to receive the product without having to pay prior to sales of the product.

In one embodiment, a designer 110 can invite manufacturer A 180 to the computer platform 100 to collaborate on the making of the product. Furthermore, a designer 110 can also add design documents, specifications to the production orders and use a commenting function within the order to go back and forth to negotiate on price, delivery dates, lead times or fine tune the design.

In one embodiment, retailer A 170 may browse through collections of products from a designer 110′s shop microsite on the computer platform 100. Alternatively, retailer A 170 may search for collections based on a keyword search on the computer platform 100 and browse the collection of choice. When viewing the collection, retailer A 170 may add the collection to the cart for placing an order. If the number of products available for sale is less than the number of products shown in the collection, retailer A 170 will be asked to confirm if he does want to proceed with adding the available products to the cart. All products in the collection that are currently available for sale will be added to the cart in one single operation.

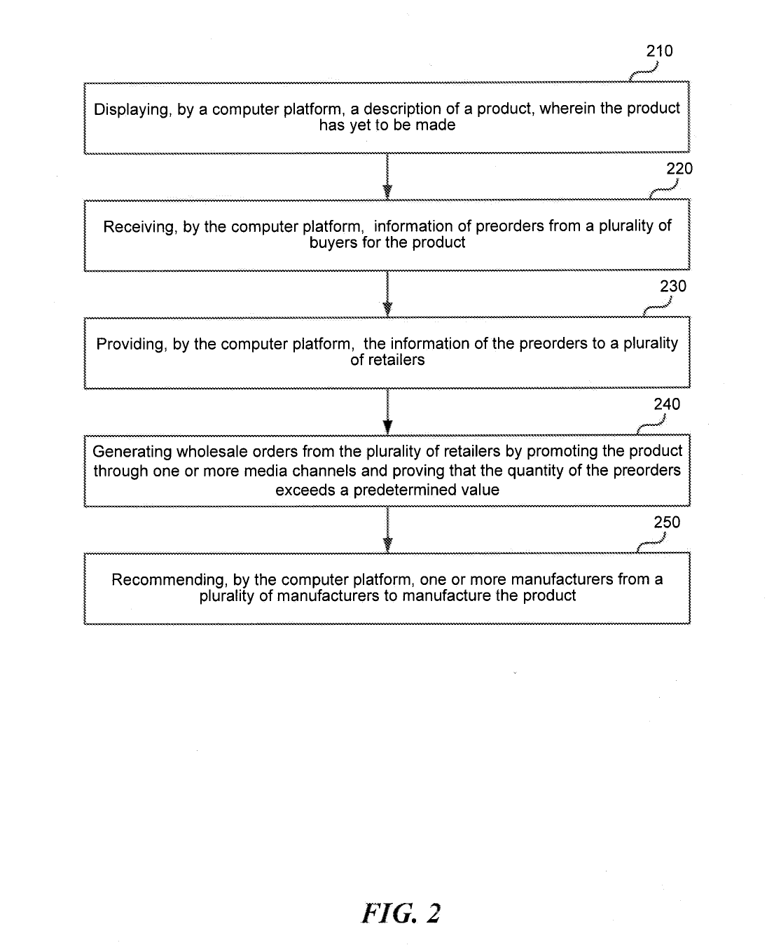

FIG. 2 illustrates a flow chart that describes an example of how the platform can facilitate the transaction in the pre-tail, e-tail and retail marketplace.

At step 210, a computer platform displays a description of a product. The product that is displayed is not been made yet. In one embodiment, the computer platform can receive a description of a product from a seller and then place the description of the product on the website associated with the computer platform. In one embodiment, the computer platform can reformat the picture or text received from a seller prior to the placement of the product information.

At step 220, the computer platform receives information of preorders from multiple buyers for the product. In one embodiment, a buyer can be an individual consumer who is browsing the internet to find the product. Alternatively, a buyer can also be a retailer who wants to place wholesale orders. In another embodiment, a buyer can also be a distributor who is a specialist who may distribute a specific product. In one embodiment, an individual buyer can be attracted by promotions of the product in the social media and then place the preorder. The buyer also can provide product comments, such as comments about the product functionality, comments about the product price and other comments.

At step 230, the computer platform provides the information of the preorders to a plurality of retailers. The information includes quantity of the preorders. For example, the computer platform receives preorders for a hat. The preorder from a buyer is 200 hats and the preorder from another buyer is 300 hats. There are only two buyers; therefore, the combined quantity of the preorders is 500. The computer platform can provide the information showing 500 pre-ordered hats to any retailer that wants to carry this hat in stock.

At step 240, the computer platform generates wholesale orders from the multiple retailers by promoting the product through one or more media channels and proving that the quantity of the preorders exceeds a predetermined value. The quantity of wholesale orders is determined based at least in part upon the quantity of the preorders. In one embodiment, the computer platform receives preorders for a hat with a specific design. The preorder from a buyer is 200 hats and the preorder from another buyer is 300 hats. There are only two buyers; therefore, the combined quantity of the preorders is 500. The computer platform can provide the information showing 500 pre-orders for hats to any retailer that wants to carry this hat in stock. In one embodiment, a retailer sets a threshold value for this hat, for example, 450 hats, to trigger an automatic alert and a wholesale order for a certain amount of hats. The certain amount of hats being ordered will be determined at least in part upon the quantity of the preorders. In one embodiment, a retailer may decide to place a wholesale order of 50 hats, 10% of the quantity of the pre-orders, after the retailer learned that 500 hats have been pre-ordered. In one embodiment, the platform can drive traffic to a website and promote designer specific campaigns via search, email, social media, public relations efforts, platform-owned channels, strategic partnerships with media partners, design bloggers and other methods. In another embodiment, the platform provides integrated marketing tools for designers to amplify the brand voice across multiple channels.

At step 250, the computer platform recommend one or more manufacturers from multiple manufacturers to manufacture the product. The manufacturing of the product is funded at least in part by funds from the preorders. The recommendation of the one or more manufacturers is based on at least any of the following: reputation, past experience, and customer reviews of the multiple manufacturers.

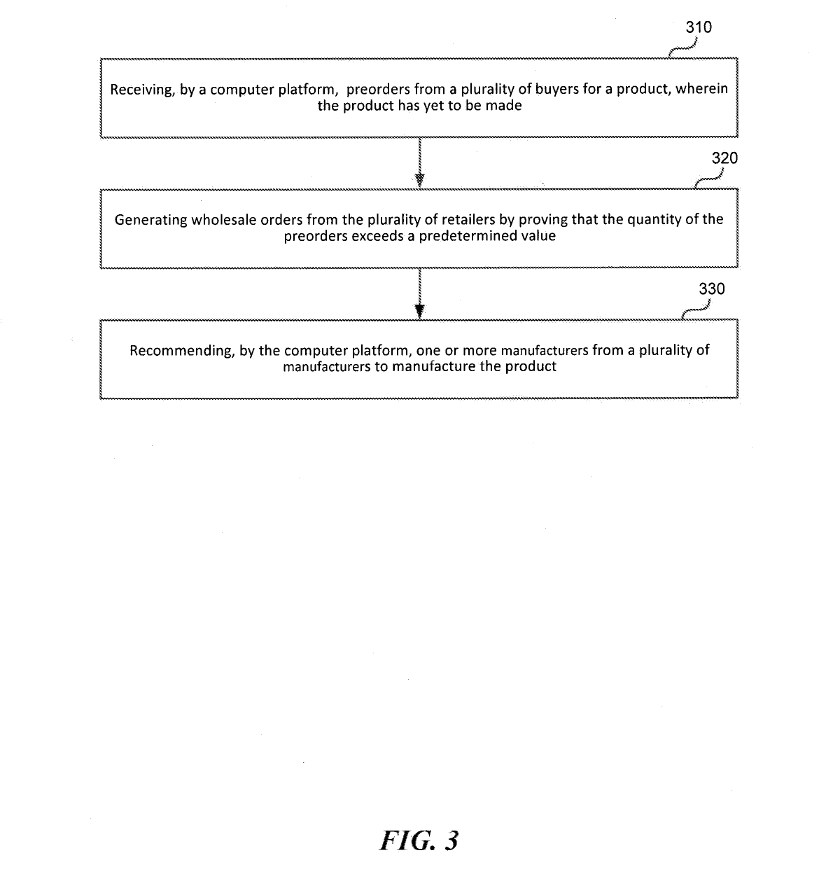

FIG. 3 illustrates a flow chart that describes another example of how the platform can facilitate the transaction in the pre-tail, e-tail and retail marketplace.

At step 310, the computer platform receives information of preorders from a plurality of buyers interested in the product. The product that is displayed, however, has not yet been made. In one embodiment, a buyer can be an individual consumer who is browsing the internet to find the product. Alternatively, a buyer can also be a retailer interested in placing wholesale orders. In another embodiment, a buyer can also be a distributor who is a specialist who may distribute a specific product. In one embodiment, an individual buyer can be attracted by the promotions of the product in the social media and then place the preorder. The buyer also can provide product comments, such as comments about the product functionality, comments about the product price, and other comments.

At step 320, the computer platform generates wholesale orders from the plurality of retailers by promoting the product through one or more media channels and proving that the quantity of the preorders exceeds a predetermined value. The quantity of wholesale orders is determined based at least in part upon the quantity of the preorders. In one embodiment, the computer platform receives preorders for a hat. The preorder from a buyer is 200 hats and the preorder from another buyer is 300 hats. There are only two buyers; therefore, the combined quantity of the preorders is 500. The computer platform can provide the information showing 500 pre-ordered hats to any retailer that wants to carry this hat in stock. In one embodiment, a retailer sets a threshold value for this hat, for example, 450 hats to trigger an automatic alert and a wholesale order for a certain amount of hats. The number of hats being ordered will be determined at least in part by the quantity of the preorders. In one embodiment, a retailer may decide to place a wholesale order of 50 hats, 10% of the quantity of the pre-orders, after the retailer learned that 500 hats have been pre-ordered. In one embodiment, the platform can drive traffic to a website and promote designer specific campaigns via search, email, social media, public relations efforts, platform-owned channels, strategic partnerships with media partners, design bloggers, and other methods. In another embodiment, the platform provides integrated marketing tools for designers to amplify the brand voice across multiple channels.

At step 330, the computer platform recommends one or more manufacturers from a plurality of manufacturers to manufacture the product. The manufacturing of the product is funded at least in part by funds from the preorders. The recommendation of the one or more manufacturers is based on at least any of reputation, past experience and customer reviews.

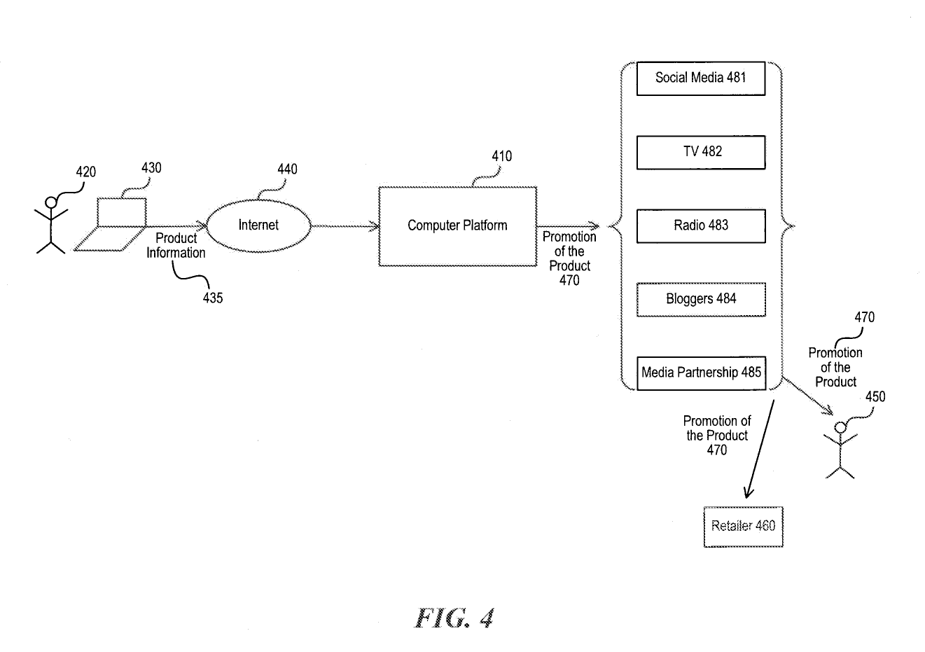

FIG. 4 illustrates an example of how the computer platform promotes products by using multiple channels.

A seller 420 can submit product information 435 through a personal computer 430 to the computer platform 410. The transmission can go through the Internet 440. In one embodiment, computer platform 410 can conduct a promotion activity by passing the promotion of the product 470 information to multiple channels. The multiple channels can include social media 481, TV 482, radio 483, bloggers 484 and media partners 485. The multiple channels can broadcast the promotion of the product 470 to an individual buyer 450. The multiple channels can also broadcast the promotion of the product 470 to a retailer 460.

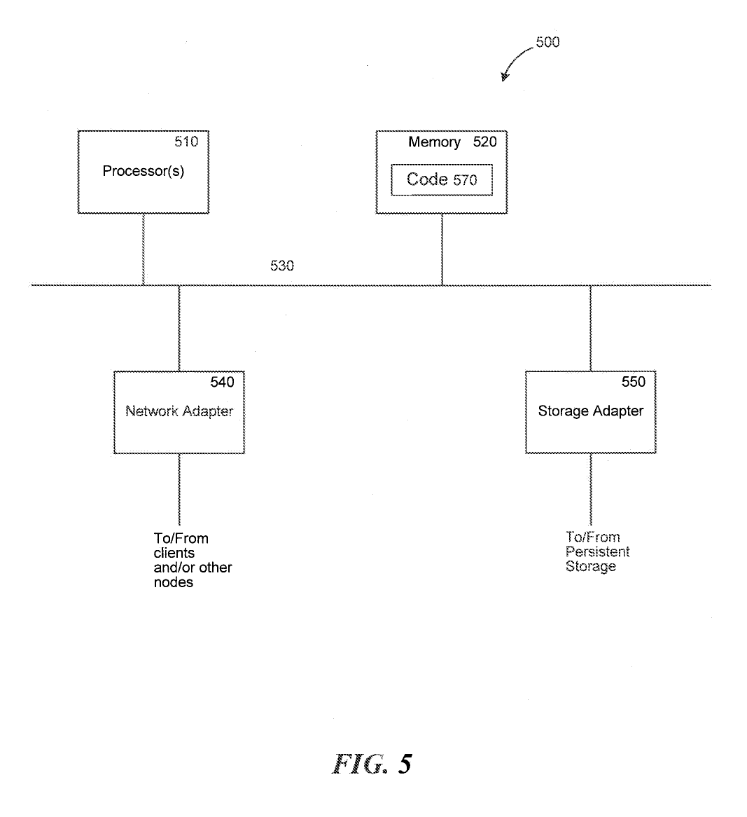

FIG. 5 is a high-level block diagram showing an example of the architecture of a computer server, which may represent any computer running the database management system described herein. The server 500 includes one or more processors 510 and memory 520 coupled to an interconnect 530. The interconnect 530 shown in FIG. 5 is an abstraction that represents any one or more separate physical buses, point-to-point connections, or both connected by appropriate bridges, adapters, or controllers. The interconnect 530, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 510 is the central processing unit (CPU) of the server 500, and thus, controls the overall operation of the server 500. In certain embodiments, the processor(s) 510 accomplishes this by executing software or firmware stored in memory 520. The processor(s) 510 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 520 is, or includes, the main memory of the server 500. The memory 520 represents any form of random access memory (RAM), read-only memory (ROM), flash memory, or the like, or a combination of such devices. In use, the memory 520 may contain a code 570, containing instructions according to the techniques disclosed herein.

Also connected to the processor(s) 510 through the interconnect 530 are a network adapter 540 and a storage adapter 550. The network adapter 540 provides the server 500 with the ability to communicate with remote devices over a network and may be, for example, an Ethernet adapter or Fibre Channel adapter. The network adapter 540 may also provide the server 500 with the ability to communicate with other computers. The storage adapter 550 allows the server 500 to access a persistent storage and may be, for example, a Fibre Channel adapter or SCSI adapter.

The code 570 stored in memory 520 may be implemented as software and/or firmware to program the processor(s) 510 to carry out actions described above. In certain embodiments, such software or firmware may be initially provided to the server 500 by downloading it from a remote system through the server 500 (e.g., via network adapter 540).

The techniques introduced herein can be implemented by, for example, programmable circuitry (e.g., one or more microprocessors) programmed with software and/or firmware, by special-purpose hardwired circuitry, or by a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.).

The term “logic”, as used herein, can include, for example, circuitry programmed with specific software and/or firmware, special-purpose hardwired circuitry, or a combination thereof.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

1. A computer-implemented method, comprising:
receiving, by a computer platform, preorders from a plurality of buyers for a product, wherein the product is yet to be made, wherein information of the preorders is forwarded to a plurality of retailers, wherein the information of the preorder includes at least quantity of the preorders;
generating wholesale orders from the plurality of retailers by proving that the quantity of the preorders exceeds a predetermined value, wherein quantity of wholesale orders is determined based at least in part upon the quantity of the preorders; and
recommending, by the computer platform, one or more manufacturers from a plurality of manufacturers to manufacture the product, wherein the manufacturing of the product is funded at least in part by funds from the preorders.

2. A computer-implemented method of claim 1, wherein the product is any of a new product, a new collection by a designer, a limited edition launch of an existing product.

3. A computer-implemented method of claim 1, wherein the information of the pre-orders includes comments to enhance the product from the plurality of buyers.

4. A computer-implemented method of claim 1, wherein the computer platform promotes the product via internet search, email campaigns, social media campaigns, public relations campaigns, traditional media campaigns, design bloggers, and strategic partnerships with media partners.

5. A computer-implemented method of claim 1, wherein the computer platform provides integrated marketing tools, wherein the integrated marketing tools are any of social media tools, email tools, and internet search tools.

6. A computer-implemented method of claim 1, wherein the plurality of retailers have choice to receive the product without having to pay prior to sales of the product.

7. A computer-implemented method of claim 1, wherein a description of the product is submitted to the computer platform by a seller.

8. A computer-implemented method, comprising:
displaying, by a computer platform, a description of a product, wherein the product is yet to be made;
receiving, by the computer platform, information of preorders from a plurality of buyers for the product;
providing, by the computer platform, the information of the preorders to a plurality of retailers, wherein the information of the preorder includes at least quantity of the preorders;
generating wholesale orders from the plurality of retailers by promoting the product through one or more media channels and proving that the quantity of the preorders exceeds a predetermined value, wherein quantity of wholesale orders is determined based at least in part upon the quantity of the preorders;
recommending, by the computer platform, one or more manufacturers from a plurality of manufacturers to manufacture the product, wherein the manufacturing of the product is funded at least in part by funds from the preorders, wherein the recommending of the one or more manufacturers is based on at least any of reputation, past experience and customer reviews of the plurality of manufacturers.

9. A computer-implemented method of claim 8, wherein the product is any of a new product, a new collection by a designer, a limited edition launch of an existing product.

10. A computer-implemented method of claim 8, wherein the information of the pre-orders includes comments to enhance the product from the consumers.

11. A computer-implemented method of claim 8, wherein the computer platform promotes the product via internet search, email campaigns, social media campaigns, public relations campaigns, traditional media campaigns, design bloggers, and strategic partnerships with media partners.

12. A computer-implemented method of claim 8, wherein the computer platform provides integrated marketing tools, wherein the integrated marketing tools are any of social media tools, email tools, and internet search tools.

13. A computer-implemented method of claim 8, wherein the plurality of retailers have choice to receive the product without having to pay prior to sales of the product.

14. A computer system comprising:
a processor;
a memory storing instructions which, when executed by the processor, cause the computer system to perform a process including:
receiving, by a computer platform, preorders from a plurality of buyers for a product, wherein the product is yet to be made, wherein information of the preorders is forwarded to a plurality of retailers, wherein the information of the preorder includes at least quantity of the preorders;
generating wholesale orders from the plurality of retailers by proving that the quantity of the preorders exceeds a predetermined value, wherein quantity of wholesale orders is determined based at least in part upon the quantity of the preorders; and
recommending, by the computer platform, one or more manufacturers from a plurality of manufacturers to manufacture the product, wherein the manufacturing of the product is funded at least in part by funds from the preorders.

15. A computer-implemented method of claim 14, wherein the product is any of a new product, a new collection by a designer, a limited edition launch of an existing product.

16. A computer-implemented method of claim 14, wherein the information of the pre-orders includes comments to enhance the product from the consumers.

17. A computer-implemented method of claim 14, wherein the computer platform promotes the product via internet search, email campaigns, social media campaigns, public relations campaigns, traditional media campaigns, design bloggers, and strategic partnerships with media partners.

18. A computer-implemented method of claim 14, wherein the computer platform provides integrated marketing tools, wherein the integrated marketing tools are any of social media tools, email tools, and internet search tools.

19. A computer-implemented method of claim 14, wherein the plurality of retailers have choice to receive the product without having to pay prior to sales of the product.
